(19) United States
(12) Patent Application Publication
(10) Pub. No.: US 2015/0294073 A1
(43) Pub. Date: Oct. 15, 2015

(54) Temperature-Corrected Blood Glucose Concentration and Decision Making in a Patient-Interactive System

(71) Applicant: EosHealth, Inc., Houston, TX (US)

(72) Inventor: Kimon J. Angelides, Houston, TX (US)

(73) Assignee: EosHealth, Inc., Houston, TX (US)

(21) Appl. No.: 14/266,857

(22) Filed: May 1, 2014

Related U.S. Application Data
(60) Provisional application No. 61/979,641, filed on Apr. 15, 2014.

(51) Int. Cl. G06F 19/00; G06N 5/04; G06N 7/00

(52) U.S. Cl. CPC G06F 19/345; G06N 7/00; G06N 5/04

(57) ABSTRACT

Disclosed is a deriving a rate constant to correct for the effect of heat on readings from a glucometer, when the glucometer is part of an interactive system of sending data from the glucometer to a server, and receiving messages and recommendations for action from the server. The heat from the glucometer is determined based on an estimate of the time the device has been activated and the ambient temperature, or by direct measurement. The rate constant is based on derivatives of the Arrhenius and Michaelis-Menten equations.

### BACKGROUND

Diabetes (especially Type II diabetes, which is associated with obesity) is a growing problem in the developed world. Patients with diabetes need to check their blood glucose (“BG”) levels several times a day, and adjust food intake, exercise, and insulin administration (and possibly the administration of other medications) in accordance with the BG level. The BG level is self-checked by the patient using a portable glucometer.

The normal blood glucose level (tested while fasting) for non-diabetics, should be between 70 and 100 milligrams per deciliter (mg/dL). However, this level fluctuates throughout the day. Blood sugar levels for those without diabetes and who are not fasting should be below 125 mg/dL. The blood glucose target range for diabetics, according to the American Diabetes Association, should be 90-130 mg/dL before meals, and less than 180 mg/dL after meals.

These small concentration differences must be differentiated by the glucometer to for the diabetic patient to maintain BG at desired levels. Most glucometers rely on an enzymatic reaction of glucose (the enzyme being one of glucose oxidase, hexokinase or glucose dehydrogenase) and then measurement of the change in current flow or voltage drop through a measured volume of the post-reaction solution. The enzyme is generally coated on a test strip, which is contacted with a drop of the patient's blood. The test strip is inserted into a port in the meter, where the determination of current flow or voltage drop change is conducted internally.

Because measuring BG levels includes an enzymatic reaction, the measurement is temperature-dependent—enzyme kinetics change as temperature varies. While glucometers were initially stand-alone devices, there is increased use and interest in having an interactive device, which both measures BG (as well as food intake, exercise and related parameters) and also provides instructions on optimizing diet, exercise and insulin administration based on the BG levels. See, e.g., US Publ'n Nos. 20130187780; 20130035563 (both incorporated by reference). The increased computing power with such devices requires increased power consumption, and generates increased heat as a by-product. The devices are designed to be portable, and cooling fans therefore cannot be accommodated. The residual heat generated by these devices will therefore affect BG level determination, as well as an array of instructions and education provided the patient, and therefore, the patient's decisions on food intake, exercise and insulin administration. There is a need to correct for the effects of residual heat on BG level determination.

### SUMMARY

In the systems set forth in prior applications (US Publ'n Nos. 20130187780; 20130035563) patient preferences, particularly for diet and exercise, are input into a portable device and then continuously updated, and suggestions for consuming similar foods, and undertaking similar exercise regimens, are made. In these systems, the patient's BG level and other monitored information is sent to a server for centralized monitoring, recording, analysis and sending of recommendations and education to the patient. Preferably, the patient's BG levels and the information are sent over a wireless link, e.g., the cellular GPRS-communication linked glucometer-pedometer, described in U.S. Pat. No. 8,066,640 (incorporated by reference), and are preferably also recorded on the portable glucometer device carried by the patient.

In the preferred system, the patient would initially enter a number of food and exercise preferences and limitations (like food exclusions due to, e.g., allergies or physical limitations, if applicable) at initiation. Depending on the blood glucose level, ketone (and other metabolite) levels, exertion level, time and content of last meal, patient feelings, and last insulin administration, the patient is provided recommendations for food consumption, continuation or cessation of exercise, insulin administration; and the patient can also be provided emergency notifications like “stop driving” or “eat immediately,” or “stop exercising.” The patient is also provided educational messages related to the monitored information received and the recorded preferences, relating to, for example, the particular health risks associated with high blood glucose levels. These messages and the ability of the system to account for patient preferences and limitations in making recommendations, help to motivate the patient to adhere to the diet, exercise and testing regime, and thereby improve clinical outcomes for patients in the system.

In these processes of selection of messages to the patient, whether the BG level exceeds or falls below threshold levels is weighted more heavily in selection (and there is mandatory selection of certain messages at certain thresholds) than are other factors in the selection process, such as: time from last meal, time until next meal, calories consumed from carbohydrate, or exertion level. BG level must therefore be reliable, within a specified error range. Moreover, BG level is intended to be an objective measure in the selection process, less subject to user mistake or prevarication (the FDA also has BG level confidence/reliability requirements for a glucometer).

In a preferred message selection process, the BG level is first corrected for temperature before it is used in message selection. The correction can be done using a derived rate constant. Temperature correction is important because determination of BG level by a glucometer involves an enzyme catalyzed reaction, which is affected by temperature. A temperature-corrected rate constant is applied to the rate equation describing the reaction kinetics involved in BG level determination, in order to correct the BG level determined by the glucometer to a more accurate, more reliable value. The temperature-corrected BG level is then applied, sometimes with other factors, in selecting recommendations and educational messages for the patient by the server, which are then transmitted to the patient's device.

The temperature of the reaction measured in determining BG level can be estimated from the length of time the device was activated and the ambient temperature. Or the temperature in the vicinity of the reaction can be measured directly.

A number of threshold BG levels may be established which either control exclusively or are included in determination (preferably as a weighted value) of which messages are sent. Such thresholds can be established for a particular single reading of a single BG level. Thresholds can also be established for average BG levels over time; like: daily, weekly and monthly averages of BG levels. Thresholds and other factors can also be weighted and then summed to achieve a score of the relevant factors used in selecting which messages the patient receives.

### DETAILED DESCRIPTION

To more accurately determine BG level, the temperature experienced by a glucose test strip inserted into the glucometer device testing port is either measured, or is estimated based on: the length of time the device has been in active (heat-generating) mode and the ambient temperature. Between activations, the device goes into a sleep mode where power use and heat generation is minimized. The internal temperature of the device tends to ambient when it is asleep.

The device's internal temperature does not increase linearly over time but is described by a differential equation, allowing determination of heat per unit volume:

$$\frac{\partial u}{\partial t} = α ( \frac{{\partial }^{2} u}{\partial {x}^{2}} + \frac{{\partial }^{2} u}{\partial {y}^{2}} + \frac{{\partial }^{2} u}{\partial {z}^{2}} ) + \frac{1}{{c}_{p} ρ} q .$$

Where q is a function representing the rate of heat generated per unit volume; u=u(x, y, z, t) is temperature as a function of space and time; p is the mass density; and cₚ is the specific heat capacity. Alternatively, the determination of the internal device temperature in the vicinity of the testing port where it accepts a glucose strip can be determined empirically (with a thermometer) for a range of ambient temperatures and for differing times from activation, to form a table of values for correlating different ambient temperatures and times from activation with a temperature at the glucose strip region of the device. Or in another alternative, the device can include a thermometer to measure directly the temperature in the vicinity of the testing port.

Calculating the device's internal temperature with the differential equation above (or calculating it empirically) allows one to correct for the effect of temperature on the enzyme kinetics involved in BG level determination, and to thereby determine BG level more accurately. The correction can be readily done by determining the rate constant for the enzymatic reaction at that temperature and then using the temperature-corrected rate constant in the reaction equation used in determining BG level. The corrected rate constant can be determined from the Arrhenius equation,

k=Ae^{-E}^{ₐ}^{/(RT)}

wherein k is the rate constant of a chemical reaction of the absolute temperature T (in kelvin), Eₐ is the activation energy, and R is the Universal gas constant. The rate constant can preferably be determined from the modified Arrhenius' equation, which makes explicit the temperature dependence of the pre-exponential factor “A” in the Arrhenius equation. The modified Arrhenius' equation allows arbitrary temperature dependence of the pre-exponential factor “A,” such that the Arrhenius description becomes overcomplete, and the problem of determining the pre-exponential factor and activation energy from experimental data becomes singular. The modified Arrhenius' equation is:

k=A(T/T₀)ⁿe^{-E}^{ₐ}^{/(RT)}

wherein T₀ is a reference temperature and allows n to be a unitless power. The original Arrhenius expression above corresponds to n=0. Fitted rate constants typically lie in the range −1<n<1. Theoretical analyses yield various predictions for n.

Using the temperature-dependent rate constant obtained by either the original or modified Arrhenius equation, the BG level is estimated by assuming first order kinetics (i.e., only one substrate, which is glucose) and applying a Michaelis-Menten equation, and then determining the initial substrate concentration, which is the BG level. The Michaelis-Menten equation describes how the (initial) reaction rate v₀ depends on the position of the substrate-binding equilibrium and the rate constant k₂.

$${v}_{0} = \frac{{V}_{max} [ S ]}{{K}_{M} + [ S ]}$$

wherein:

$$\begin{matrix}{K}_{M} {=}^{def} \frac{{k}_{2} + {k}_{- 1}}{{k}_{1}} \approx {K}_{D} \\ {V}_{max} {=}^{def} {{k}_{cat} [ E ]}_{tot}\end{matrix}$$

Where: [E] is the enzyme concentration in the reaction mixture; and K_{cat} is the rate of formation of the reaction product, and is made up of:
the rate of enzyme-substrate binding which is K₁; the rate of enzyme-substrate dissociation which is K−₁; and the rate of enzyme-substrate reaction to form product, which is K₂.

The remaining substrate after each time period can be expressed as follows (where [S]₀ is the initial substrate concentration):

[S]=[S]₀(1−(Vₘₐₓ[S]₀/K_{M}+[S]₀/[S]₀))^{t}

The product generated at each time period can be extrapolated from the determination of [S].

An improved solution allowing determination of the concentration of remaining substrate over time (and thus the concentration of product generated) is:

$$\frac{[ S ]}{{K}_{M}} = W [ F ( t ) ] - \frac{{V}_{max}}{{k}_{cat} {K}_{M}} \frac{W [ F ( t ) ]}{1 + W [ F ( t ) ]}$$

where W[ ] is the Lambert-W function, and where F(t) is

$$F ( t ) = \frac{{[ S ]}_{0}}{{K}_{M}} exp ( \frac{{[ S ]}_{0}}{{K}_{M}} - \frac{{V}_{max}}{{K}_{M}} t )$$

In the invention, one assumes that the determination of [S] or [S]₀ or concentration of reaction product is based on the measured current flow change, including the rate of current flow increase, or voltage drop change, and this initial determination then needs to corrected to reflect K_{M} at the actual reaction temperature in order to determine the actual, corrected BG level (which is [S]₀ in the equation above). As elevated internal temperatures generally tend to increase the reaction rate (though, there is a threshold beyond which the enzyme catalyst will be inactivated), the BG level obtained when the device has been operational and has heated, needs to be corrected by reduction. As explained above, the correction factor follows the device internal temperature, which is a function of the time from device activation up to a limit at which the temperature stabilizes, after which the correction factor is constant.

Certain threshold BG levels are accepted as associated with adverse clinical events or an unacceptable risk thereof. Accurate determination of BG level is needed to avoid or ameliorate adverse events (or an unacceptable risk thereof).

Table 1 below illustrates some of these threshold BG levels and recommended actions (which are sent to the patient from the server in the form of messages) when they are violated. Table 1 below also illustrates that educational messages sent to the patient (as exemplified in US Publ'n No. 2013-0035563, incorporated by reference) are the educational messages associated with BG levels above or below a number of particular threshold BG levels. The particular thresholds are not necessarily the ones listed in Table 1, and can include others or differ from those listed in Table 1.

Although not shown in Table 1, multiple educational messages can also be sent to the patient, so that one or more are associated with BG levels above or below a particular threshold, and others are widely-distributed and sent to all patients. These widely distributed educational messages include those for general education about the disease of diabetes and effects of particular actions. For example, these general education messages could be any of: “Snack on whole grain, low fat chips or popcorn. Cook with whole grain flour. Try to eat at least three 3 oz servings of whole grains each day.” See US Publ'n No. 2013-0035563.

TABLE 1

| BG Level | | Risked Events | Recommendations | Educational Message |
|---|---|---|---|---|
| >250 | mg/dL | Ketosis | Check ketone level; | Those associated with |
| | | | administer insulin; no | BG >250 mg/dL |
| | | | carbohydrates | |
| >180 | mg/dL | Hyperglycemia | administer insulin; no | Those associated with |
| | | | carbohydrates; exercise | BG >180 mg/dL |
| >125 | mg/dL | Moderate | no carbohydrates; exercise | Those associated with |
| | | Hyperglycemia | | BG >125 mg/dL |
| <90 | mg/dL | Hypoglycemia | Eat carbohydrates; cease | Those associated with |
| | | | exertion | BG <90 mg/dL |
| <70 | mg/dL | Hypoglycemia | Eat glucose; cease exertion; | Those associated with |
| | | | follow The Rule of 15 in | BG <70 mg/dL |
| | | | Table 2 below | |

Where the BG level is less than 70 mg/dL, as discussed in US Publ'n No. 2013-0035563 (incorporated by reference), the patient is instructed by message to follow the rule in Table 2 below. Again, accurate determination of BG level (i.e., as corrected for temperature) is extremely important as it controls the message sent to the patient and the patient's actions.

TABLE 2
The RULE OF 15:

If your blood glucose (sugar) is less than 70 mg/dl or if you are
experiencing hypoglycemic symptoms complete the following steps:
I) Treat with 15 gm of fast acting glucose or equivalent as listed above.
2) Wait 15 minutes and rest.
3) If your blood glucose level is still less than 70 mg/dl or if you still
have symptoms listed above REPEAT steps I and 2
4) If you feel better after either the 1st or 2nd treatment then you NEED to
eat the next snack or meal as indicated below:
A) If your next meal or snack is not scheduled for 30-60 minutes, eat a
snack that contains 15 grams of carbohydrate.
B) If your next meal is more than 60 minutes away, eat 15 gm of
carbohydrates and 1 ounce of protein.
5) If you are unable to correct hypoglycemia after two (2) treatments you
need to seek IMMEDIATE medical care. DO NOT DRIVE YOURSELF.
DO NOT GIVE OR TAKE FLUIDS IF UNCONSCIOUS OR UNABLE
TO SWALLOW

Where the BG level is between about 90 and 180 mg/dL, the recommendations selected preferably include insulin administration, eating and exercising based on additional factors to the BG level, including: patient feelings, when the next meal is expected, the carbohydrate and other nutrient content of the last meal consumed, as well as the exertion level of the patient. Where the BG level is between about 90 and 180 mg/dL, the recommendations to the patient could also be based on time averaged analysis of the BG level and the time averaged analysis of some of the additional factors, particularly, on carbohydrates consumed over time; and length of exercise time per time period. The averaging can be, for example, over one day, one week, one month or over some other interval.

The additional factors (or BG level) can also be weighted in the process of selecting patient recommendations, such that the presence of particular BG levels or certain additional factors has greater weight in determining which of several recommendations is selected and transmitted to the patient. The weighting can be based on, for example, the factor's clinical significance. Factors which have greater clinical significance (i.e., BG level, patient feelings) would likely be weighted more heavily in the selection of recommendations for the patient. Ill feelings are a generally reliable guide to the patient's clinical condition.

As an example of weighting: if the patient has engaged in heavy exertion for an extended period (as detected, for example, by a pedometer, as disclosed in US Publ'n No. 20130035563) this would trigger selecting an instruction involving consuming carbohydrate soon; in the absence of other countervailing factors. See Table 3, middle column. But if the BG level is above 125 mg/dL or approaching 180 mg/dL and at the same time, the patient has light-headedness and other hypoglycemic symptoms, the greater weight attached to BG level would override the normal recommendation to consume carbohydrates, and instead the instruction would be: “Do not eat any carbs for at least one hour” and “Inject insulin immediately.” See Table 4.

As an example of averaging of BG levels and then weighting the averaged level in choosing a recommendation: if the averaged BG levels show that the BG level rises to well above 125 mg/dL after meals, this can be weighted so that instead of an instruction to “Eat about 15 g of carbs within one hour” (Table 4) at the time for a next meal, the recommendation would instead be “Do not eat any carbs for at least one hour.”

A table of additional factors to be weighted would look like those in Table 3:

TABLE 3
Additional Factors to be Weighted

| Exertion | Carbohydrates | Time to Next | Patient | |
|---|---|---|---|---|
| Level | at Last Meal | Meal | Feelings | BG Level |
| High | Less than 15 g | More than | Light-headed | Less than |
| | | one hour | or other | 125 mg/dL |
| | | | hypoglycemic | |
| Low or | More than 15 g | Less than | No | More than |
| None | | one hour | hypoglycemic | 125 mg/dL |

The first row in Table 3 is a set of factors all associated with a need to consume carbohydrates and not administer insulin, and the second row is a set of factors all associated with a need to inject insulin and avoid carbohydrates. In Table 3, the weighting of each factor could increase from left to right, i.e., “Exertion Level” would have the lowest weight and passing the threshold BG level (125 mg/dL) would have the highest weight. Each factor (each column) can be subdivided further, so that there are added threshold BG levels between 125 mg/dL and 180 mg/dL, and with each higher threshold, the weight of the factor in determining to instruct the patient to inject insulin and avoid carbohydrates is increased. Similarly, carbohydrates consumed at the last meal can be subdivided further by adding more thresholds, above “more than 15 g.” The weight accorded this factor in determining to instruct the patient to inject insulin and avoid carbohydrates is increased as each threshold of carbohydrate previously consumed is exceeded.

One method of weighting is to sum each weighted factor in Table 3, and then to select an appropriate set of recommendations from Table 4 based on the weighted sum. As the sum increases to a maximum one would select one instruction from each column in the top row of instructions in Table 4 (all to be sent to the patient in the event they are hypoglycemic), and then only one per column from a progressively lower row as the sum decreased to a minimum (all to be sent to the patient in the event they are hyperglycemic).

To further refine Table 3, another matrix of averaged factors can be established, which could include some or all of: average time of exercise per unit time (day, week or month); average quantity of carbohydrate consumed per unit time (day, week or month); average BG level; frequency of incidents of hypoglycemia or hyperglycemia. These could again be arranged and weighted similarly to the factors in Table 3, such that upon summation of the factors in this New Matrix, as the sum increased to a maximum one would select one from each column in the top row of instructions in Table 4 (all to be sent to the patient in the event they are hypoglycemic), and then only one per column from a progressively lower row as the sum decreased to a minimum (all to be sent to the patient in the event they are hyperglycemic). However, in the case where a New Matrix is established, before any recommendation is selected from Table 4, the New Matrix weighted sum would need to be used with (or summed with) the sum from weighting the applicable factors in Table 3; to thereby make a New Sum. The New Sum would then account for acute conditions and reactions to them (as in Table 3) as well as time averaged experience, both of which would be used to select a recommendation from Table 4.

TABLE 4
Recommendations to be Selected

| | | |
|---|---|---|
| Cease exertion | Eat about 15 g of | Do not inject insulin |
| | carbs immediately | |
| Reduce exertion | Eat about 15 g of | Inject insulin within 6 |
| | carbs within one hour | hours |
| Begin exertion | Eat about 30 g of | Inject insulin within |
| | carbs with your next | one hour |
| | meal | |
| Increase exertion | Do not eat any carbs | Inject insulin |
| | for at least one hour | immediately |

As noted above, particular sets of educational messages are associated with each BG level threshold in Table 1. There are also Additional Educational Messages selected and sent based on additional factor(s), or additional weighted factors, or additional weighted factors averaged over time. That is, the Additional Educational Messages sent can be selected the same way that recommendations are selected (i.e., using any or all of weighting, summing, a New Matrix and a New Sum) except that the factors weighted and/or summed include those in Table 5. The Additional Educational Messages are preferably sent where the BG level is between about 90 mg/dL and 180 mg/dL, as in that range, the patient is generally not running an acute clinical risk and receiving immediate warnings, and associated education messages about the risks of BG levels far outside recommended levels.

TABLE 5
Additional Educational Messages selected depending which of the following combinations of
factors (one from each column) are detected by the server:

| | | | |
|---|---|---|---|
| Patient engages in | Patient eats too little | Patient eats too few | Patient's BG level often |
| overly-frequent high | carbs | meals | falls below |
| intensity exercise | | | recommended limits |
| Patient frequently | Patient eats a | Patient eats | Patient's BG level is |
| does recommended | moderate amount of | recommended number | relatively stable and |
| levels of exercise | carbs | of small meals | within recommended |
| | | | limits |
| Patient rarely | Patient overeats carbs | Patient eats too many | Patient's BG level often |
| exercises | | meals | rises above |
| | | | recommended limits |

The factors in Table 5 are derived from the information the patient enters about diet and exercise, and the BG levels which are logged and transmitted to the server. The manner of the patient entering and transmitting such information is described in detail in US Publ'n No. 2013-0035563. The factors in Table 5 are preferably based on an averaging of patient information over time. The time of averaging can be lengthened to account for fluctuations in diet and exercise level which may reflect vacation or holiday schedules, or other out of the ordinary events for the patient. A longer term monitoring and averaging will more accurately reflect the patient's usual diet and exercise patterns.

The weighting of the factors in Table 5 in selecting an appropriate set of Additional Educational Messages would likely weight the BG level (right hand column) more heavily than the patient-reported factors in the other columns. Again, one would sum the factors in Table 5, and as the sum increased to a maximum one would select an appropriate set of Additional Educational Messages from a matrix be sent to the patient in the event they are hypoglycemic, and then as the sum decreased to a minimum, a different set of Additional Educational Messages would be sent to the patient reflecting that they are progressively more hyperglycemic.

A number of specific exemplary educational messages sent to the patient are listed in US Publ'n No. 2013-0035563. Educational messages sent when the BG level is below about 90 mg/dL and/or above about 180 mg/dL, are as indicated in Table 6 below. Again, accurate determination of BG level (i.e., as corrected for temperature) is extremely important as it controls the educational message sent to the patient.

TABLE 6
Exemplary Messages when BG level is below 90 mg/dL or above about 180 mg/dL

You must check your blood sugar more often if you are sick, if your sugar is >200 or if
you have frequent episodes of hypoglycemia.
Your fasting blood sugar should be between 70-100 mg. A fasting level is the one you
take when you have not had any food or drink for the 8 hours.
Your blood sugar should be <140, 2 hours after eating or drinking.

Exemplary Messages when BG level is below 90 mg/dL

If you are managing your diabetes with tight glucose control, check your blood sugar
level often to prevent hypoglycemia.
Sulfonylureas are medications that make the pancreas secrete more insulin; decrease the
glucose produced by the liver and allows the cells to use insulin more efficiently.
Symptoms of hypoglycemia include feeling weak, drowsy, confused, hungry, dizzy, pale,
irritable, sweating, rapid heart beat, shakiness or experiencing a cold clammy feeling.
Watch for symptoms of hypoglycemia when taking sulfonylureas.

Exemplary Messages when BG level is above 180 mg/dL

Glimipiride, Glipizide and Glyburide are all sulfonylurea medications.
Glimepiride stimulates pancreas to produce and secrete more insulin and decreases
production of glucose by the liver.
Glimepiride is available in 1 mg, 2 mg and 4 mg with a maximum 24 hours dosage of 8 mg.
Side effects of Glimepiride include hypoglycemia and skin rash.
Glimepiride must be taken with breakfast or first main meal of the day.
Glipizide stimulates pancreas to produce and secrete more insulin and helps the body to
use insulin better.
Glipizide is available in 2.5 mg, 5 mg and 10 mg with a maximum 24 hours dosage of 40 mg
for Glucotrol and 20 mg for Glucotrol-XL.
Side effects of Glimepiride include hypoglycemia, skin rash and sensitivity of skin to
sunlight.
Glipizide must be taken on an empty stomach, 30 minutes prior to breakfast. It is
commonly used in combination with Actos and Glucophage.
Glyburide stimulates pancreas to produce and secrete more insulin and helps the body to
use insulin better.
Glyburide is available in 2.5 mg, 5 mg and 12.5 mg.
Watch for hypoglycemia, skin rash and heart burn when taking Glyburide.
Glyburide must be taken with meals to reduce GI effects.
If you miss a dose of Glyburide take it as soon as you remember but skip if it is close to
the next dose. You should never take two doses at once.
Pioglitazone or Actos belongs to a class of drugs called Thiazolidinediones, which work
by improving the body's sensitivity to insulin and decreasing production of glucose and
triglycerides by the liver.
Actos is available in 15 mg, 30 mg and 45 mg and it is always prescribed once daily.
Watch for hypoglycemia, anemia and edema when taking Actos.
Actos must be taken with a main meal.

Based on all the above, the logic flow of considerations involved in selecting recommendations and educational messages to the patient would be:
Measure blood glucose level and determine a temperature corrected BG level;
If temperature corrected BG level (hereinafter “BG level”) is below a lowermost threshold (e.g., 70 mg/dL) send recommendations and educational messages for such level;
If BG level is above lowermost threshold but below a second threshold (e.g., 90 mg/dL) send recommendations and educational messages for such levels;
if BG level is above an uppermost threshold (e.g., 250 mg/dL) send recommendations and educational messages for such level;
If BG level is below uppermost threshold but above another upper threshold (e.g., 180 mg/dL), send recommendations and educational messages for such levels;

Additional Educational Messages may be selected and sent, based on:
Select one factor based on the prior entries of information from each of the columns in Table 5, and based on the combination of the factors selected or on weighting and summing of the factors, select one or more Additional Educational Messages for the patient.

If BG level is between thresholds in a quasi-acceptable range (e.g., between 90 mg/dL and 180 mg/dL):
determine if BG level is also above another hyperglycemic threshold (e.g., 125 mg/dL);
if BG level is above 125 mg/dL: recommend not eating any carbohydrate for at least one hour; recommend insulin immediately or within one hour, depending on length of time from last insulin injection and carbohydrate quantity consumed and time from last consumption; recommend beginning or increasing exertion level.
if BG level is not above 125 mg/dL: recommend not eating any carbohydrate for at least one hour; recommend insulin injection within one to six hours, depending on length of time from last insulin injection and carbohydrate quantity consumed and time from last consumption; recommend beginning or increasing exertion level; or
select recommendations and educational messages based on weighting and summing factors in Table 3 and/or by establishing a New Matrix and a New Sum.

Send Additional Educational Messages, based on:
Select one factor based on the prior entries of information from each of the columns in Table 5, and based on the combination of the factors selected or on weighting and summing of the factors, select one or more Additional Educational Messages for the patient.

As discussed in US Publ'n No. 20130187780, patient BG levels are averaged over time by the server to discern trends. Supplemental Educational Messages sent to the patient can also be based on averaged BG levels and trends in averaged BG levels. The menu of such Supplemental Educational Messages can be the same as the menu of Additional Educational Messages, but with the specific messages selected based on BG level instead of the factors in Table 5 (though the Additional Educational Messages would preferably also be sent, based on their own selection criterion).

The Supplemental Educational Messages selected would reflect, especially, cautionary notes to patients whose BG levels are often too high or too low over time. Exemplary cautionary messages include some of those in Table 6 of US Publ'n No. 2013-0035563, e.g., “High sugar levels can cause serious long term and short term health complications.”

In addition to sending recommendations and educational messages to the patient, the server can also alert health care workers of specific patient BG levels (especially if outside of the range of 90 mg/dL to 180 mg/dL such that intervention may be needed) and trends in patient BG levels, as well as diet and exercise and other relevant patient information, as discussed in US Publ'n No. 2013-0035563. The health care monitors would have the option to contact the patient personally for added persuasion to adhere to the requirements for diet, exercise and insulin administration regimens. Alternatively, the server could also communicate recommendations and educational messages to family members, to try to have them help persuade the patient to improve his or her habits. There could also be additional and different educational messages to family members, directed to persuading them to help with the education of the patient.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, any of the terms “comprising”, “including”, containing”, etc. are to be read expansively and without limitation. The methods and processes illustratively described herein suitably may be practiced in differing orders of steps, and that they are not necessarily restricted to the orders of steps indicated herein or in the claims. It is also noted that as used herein and in the appended claims, the singular forms “a,” “an,” and “the” include plural reference, and the plural include singular forms, unless the context clearly dictates otherwise. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing, by Applicants. The invention has been described broadly and generically herein. Each of the narrower species and subgeneric groupings falling within the generic, disclosure also form part of the invention.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

1. A process of selecting recommendations and educational messages for a diabetic patient using a portable device which includes a glucometer and measures patient blood glucose using enzymes which catalyze a reaction with the glucose in the patient's blood, and where the device also includes a display screen for displaying messages sent from a server and where patient data can be entered into the device, said device linked through a wireless connection to the server, comprising:
determining an uncorrected patient blood glucose level from the glucometer by measuring the change in current flow through a glucose test strip which contains the patient's blood at a time before the enzyme-catalyzed reaction reaches a steady state, where the voltage across the strip is held constant and wherein increased current flow correlates with a greater blood glucose level;
determining a corrected patient blood glucose level from the uncorrected blood glucose level by correcting for the effect of heat produced by the device on increasing the rate of the enzyme catalyzed reaction, where the Arrhenius equation or the modified Arrhenius equation is used to determine a rate constant and then the rate constant is applied using a Michaelis-Menten analysis to determine the actual concentration of glucose substrate in the patient's blood by the enzyme-catalyzed reaction, and where the temperature of the device is measured or estimated based on the length of time the device has been activated and the ambient temperature;
ascertaining if the corrected BG level is greater than a highest threshold, or one or more lower thresholds, and with respect to a patient wherein their corrected BG level is greater than a particular said threshold, wirelessly transmitting to said patient from the server a particular set of recommendations for action and educational messages associated with a corrected BG level greater than said particular threshold including an instruction to administer insulin;
ascertaining if the corrected BG level is less than a lowest threshold, or one or more higher thresholds, and with respect to a patient wherein their corrected BG level is less than a particular said threshold, wirelessly transmitting to said patient from the server a particular set of recommendations for action and educational messages associated with a corrected BG level less than said particular threshold including an instruction to consume carbohydrates; and
ascertaining if the corrected BG level is within a particular range which is between the highest and lowest thresholds, and with respect to a patient wherein their corrected BG level is within said particular range, recommendations and educational messages wirelessly transmitted to the patient from the server are based on additional factors in addition to the BG level.

2. (canceled)

3. The process of claim 1 wherein the temperature of the device is estimated using a differential equation, allowing determination of heat per unit volume of the device.

4. The process of claim 1 wherein the device further includes a pedometer which tracks the movement of the patient over time to automatically determine exercise level.

5. The process of claim 1 wherein the highest threshold which the patient's corrected BG level is greater than, is: 125 mg/dL, 180 mg/dL, or 250 mg/dL.

6. The process of claim 1 wherein the recommendations include when to administer insulin, when to eat and how much carbohydrate to eat; and whether to begin, cease, increase or decrease exercise.

7. The process of claim 1 wherein the additional factors include: patient feelings, when the next meal is expected, the carbohydrate and other nutrient content of the last meal consumed, and the exertion level of the patient.

8. The process of claim 7 wherein the recommendations and educational messages are further based on averaging or weighting or summing of the additional factors.

9. The process of claim 7 wherein weighting results in a greater likelihood of certain recommendations and educational messages being selected and sent to the patient.

10. A process of selecting recommendations and educational messages for a diabetic patient using a portable device which includes a glucometer and measures patient blood glucose using enzymes which catalyze a reaction with the glucose in the patient's blood, and where the device also includes a display screen for displaying messages sent from a server and where patient data can be entered into the device, said device linked through a wireless connection to the server, comprising:
determining an uncorrected patient blood glucose level from the glucometer by measuring the change in current flow through a glucose test strip which contains the patient's blood at a time before the enzyme-catalyzed reaction reaches a steady state, where the voltage across the strip is held constant and wherein increased current flow correlates with a greater blood glucose level;
determining a corrected patient blood glucose level from the uncorrected blood glucose level by correcting for the effect of heat produced by the device on increasing the rate of the enzyme catalyzed reaction, where the Arrhenius equation or the modified Arrhenius equation is used to determine a rate constant and then the rate constant is applied using a Michaelis-Menten analysis to determine the actual concentration of glucose substrate in the patient's blood by the enzyme-catalyzed reaction, and where the temperature of the device is estimated based on the length of time the device has been activated and the ambient temperature;
ascertaining if the corrected BG level is greater than a highest threshold, or one or more lower thresholds, and with respect to a patient wherein their corrected BG level is greater than a particular said threshold, wirelessly transmitting to said patient from the server a particular set of recommendations for action and educational messages associated with a corrected BG level greater than said particular threshold including an instruction to administer insulin, after which the patient administers insulin;
ascertaining if the corrected BG level is less than a lowest threshold, or one or more higher thresholds, and with respect to a patient wherein their corrected BG level is less than a particular said threshold, wirelessly transmitting to said patient from the server a particular set of recommendations for action and educational messages associated with a corrected BG level less than said particular threshold including an instruction to consume carbohydrates after which, the patient consumes carbohydrates; and
ascertaining if the corrected BG level is within a particular range which is between the highest and lowest thresholds, and with respect to a patient wherein their corrected BG level is within said particular range, recommendations and educational messages sent to the patient from the server are based on additional factors in addition to the corrected BG level, where said additional factors are weighted and summed, and the sum is considered with the corrected BG level in selecting from a menu of recommendations to be wirelessly transmitted to the patient by the server and in selecting from a menu of educational messages to be wirelessly transmitted to the patient by the server.

11. (canceled)

12. The process of claim 10 wherein the temperature of the device is estimated using a differential equation, allowing determination of heat per unit volume of the device.

13. The process of claim 10 wherein the device further includes a pedometer which tracks the movement of the patient over time to automatically determine exercise level.

14. The process of claim 10 wherein the highest threshold which the patient's corrected BG level is greater than, is: 125 mg/dL, 180 mg/dL, or 250 mg/dL.

15. The process of claim 10 wherein the recommendations include when to administer insulin, when to eat and how much carbohydrate to eat; and whether to begin, cease, increase or decrease exercise.

16. The process of claim 10 wherein the additional factors include: patient feelings, when the next meal is expected, the carbohydrate and other nutrient content of the last meal consumed, and the exertion level of the patient.

17. The process of claim 10 wherein the weighting results in a greater likelihood of certain recommendations and educational messages being selected and sent to the patient.

18. A process of selecting recommendations and educational messages for a diabetic patient using a portable device which includes a glucometer and measures patient blood glucose using enzymes which catalyze a reaction with the glucose in the patient's blood, and where the device also includes a display screen for displaying messages sent from a server and where patient data can be entered into the device, said device linked through a wireless connection to the server, comprising:
determining an uncorrected patient blood glucose level from the glucometer by measuring the change in current flow through a glucose test strip which contains the patient's blood at a time before the enzyme-catalyzed reaction reaches a steady state, where the voltage across the strip is held constant and wherein increased current flow correlates with a greater blood glucose level;
determining a corrected patient blood glucose level from the uncorrected blood glucose level by correcting for the effect of heat produced by the device on increasing the rate of the enzyme catalyzed reaction, where the Arrhenius equation or the modified Arrhenius equation is used to determine a rate constant and then the rate constant is applied using a Michaelis-Menten analysis to determine the actual concentration of glucose substrate in the patient's blood by the enzyme-catalyzed reaction, and where the temperature of the device is estimated based on the length of time the device has been activated and the ambient temperature;
ascertaining if the corrected BG level is greater than a highest threshold, or one or more lower thresholds, and with respect to a patient wherein their corrected BG level is greater than a particular said threshold, wirelessly transmitting said patient from the server a particular set of recommendations for action and educational messages associated with a corrected BG level greater than said particular threshold including an instruction to administer insulin, after which the patient administers insulin;
ascertaining if the corrected BG level is less than a lowest threshold, or one or more higher thresholds, and with respect to a patient wherein their corrected BG level is less than a particular said threshold, wirelessly transmitting said patient from the server a particular set of recommendations for action and educational messages associated with a corrected BG level less than said particular threshold including an instruction to consume carbohydrates after which, the patient consumes carbohydrates; and
ascertaining if the corrected BG level is within a particular range which is between the highest and lowest thresholds, and with respect to a patient wherein their corrected BG level is within said particular range, recommendations and educational messages transmitted to the patient from the server are based on additional factors in addition to the corrected BG level, where said additional factors are weighted and summed, and a greater weighting of the additional factors in combination with consideration of the corrected BG level results in a greater likelihood of selecting certain recommendations from a menu of recommendations to be sent to the patient by the server and in selecting from a menu of educational messages to be sent to the patient by the server.

19. The process of claim 18 wherein the additional factors include: patient feelings, when the next meal is expected, the carbohydrate and other nutrient content of the last meal consumed, and the exertion level of the patient.

20. The process of claim 18 wherein the portable device also includes a pedometer.
